(19) United States
(12) Patent Application Publication
(10) Pub. No.: US 2010/0308620 A1
(43) Pub. Date: Dec. 9, 2010

(54) Passenger Bus Body And Method Of Making

(75) Inventors: Leo Oriet, Rochester Hills, MI (US); Nouri Matar, Scarborough (CA)

Correspondence Address: International Truck Intellectual Property Company,, 4201 WINFIELD ROAD, WARRENVILLE, IL, 60555, US

(73) Assignee: Navistar Canada, Inc., Warrenville, IL (US)

(21) Appl. No.: 12/478,346

(22) Filed: Jun. 4, 2009

(51) Int. Cl. B62D 31/00; B29C 45/00; B29C 47/00

(52) U.S. Cl. 296/178; 264/328.1; 264/176.1

(57) ABSTRACT

A passenger bus body is fabricated in a mold by introducing resin and reinforcing fibers into a cavity of the mold that causes the introduced material to seamlessly join lengthwise margins of the roof (18, 18A) with upper lengthwise margins of the side walls (14, 16; 14A, 16A) and to seamlessly join lengthwise margins of the floor (12, 12A) with the lower lengthwise margins of the side walls. Floor rails (32, 34) of structural composite can eliminate the need for a separate metal chassis frame.

### FIELD OF THE INVENTION

This invention relates to passenger buses, especially passenger bus bodies.

### BACKGROUND OF THE INVENTION

The school bus manufacturing industry fabricates bus bodies using a “stick framing” process. That process is heavily labor- and part-intensive. Actual fabrication process sheets call for specific operations too numerous to mention here; hence only a general overview of the process will be given as background.

A number of bows are fabricated and installed at intervals along the length of the bus body. Fixtures for locating and holding the bows are placed on seat rails that run along opposite sides of the floor. The bows are manually placed in the fixtures and preliminarily fastened in place. Drip rails and bow spacers are located to the bows using other fixtures. The preliminarily assembled parts are checked for squareness and fit, adjusted as needed, and checked again before parts are finally joined together using fasteners and welding. Certain bus specifications may call for reinforcement of the bows in various ways, adding more steps and parts to the fabrication process. Trimming of certain parts may also be required. Eventually the body sides are closed by exterior side panels, and the open top of the body is capped by fitting the roof onto the bows and fastening it in place.

At some stage of its manufacture, the bus body, which is essentially entirely metal, is ready to be primed and painted. For a large vehicle body, such as a bus body, a significant amount of paint and primer are needed. So too is a large paint booth and paint oven area in the manufacturing plant.

At some further points in the bus manufacturing process, windows are installed and the body is mounted on a medium duty truck chassis frame. The frame serves to mount an engine for propelling the bus and suspension systems for the wheels. Various components of a drivetrain that couples the engine to driven ones of the wheels are also supported on the frame, as are components of various other systems such as brake and steering systems.

When a bus is being driven, various road forces are exerted on the chassis frame and transmitted in at least some degree to the bus body. Because buses may operate in rural areas where roads are often unimproved and in geographic locations where extreme weather conditions can occur, such road forces and weather extremes will contribute to wear and tear on a bus and its many components both in the chassis and in the body. Over time, the accumulated effect of these conditions can loosen parts and degrade the quality of ride and road handling performance Buses that operate in winter conditions may be exposed to the corrosive effect of road salt that is often used to melt ice and snow.

Consequently, in order for a bus manufacturer to provide an acceptable commercial life for a bus, the structure of the body and chassis must be strong, durable, and resistant to corrosion, but to be competitive, the overall body weight and the manufacturing costs must be carefully controlled without sacrificing product quality.

The entire automotive vehicle industry, which includes trucks, cars, and other vehicles as well as buses, is constantly striving to increase fuel economy and/or to eliminate reliance on traditional liquid fuels for vehicle propulsion. Weight reduction based on lighter materials can be a contributor to those objectives. However, a bus that is propelled by a hybrid electric, or a totally electric, powerplant, will be subject to an inherent increase in weight due to the addition of electric components to a combustion engine to create a hybrid powerplant or the replacement of a combustion engine by a large electric motor and associated battery or fuel cell bank. In order to achieve meaningful weight reductions that will significantly compensate for the added weights of such powerplants, the inventors have realized that the construction of the bus body should be fundamentally changed.

### SUMMARY OF THE INVENTION

The present invention relates to novel constructions for passenger bus bodies that can eliminate most of the body parts and manufacturing steps currently used and that can reduce the amount of labor and manufacturing space needed for motor bus body manufacture while providing bus bodies that can offer a longer useful life during which less maintenance is required. Especially importantly, these novel constructions provide substantial weight reductions that do not compromise the structural strength of a bus body.

Bus body structures of the present invention embody engineered materials that form what the inventors consider to be “one-piece” fuselage structures. The use of certain engineered materials provides a body structure having an underbody of such structural strength that the conventional medium duty truck frame referred to earlier can be eliminated. That allows buses to be assembled in a significantly smaller assembly plant. The use of other engineered materials requires that the body be mounted on a separate chassis frame containing the engine, the drivetrain, and suspension systems that suspend the road wheels.

A bus body structure embodying principles of the present invention can provide a commercial bus body manufacturer with a significant competitive advantage by delivering greater value to customers.

A bus body structure manufactured in accordance with principles of the present invention also enjoys a significant weight savings (as much as about 40%) in comparison to the largely steel bodies currently commercially manufactured. Reduced weight provides the obvious advantages of larger load capacity and improved fuel efficiency regardless of the particular powerplant, but the significant weight reduction provided by the invention will be an especially important factor for accelerating the use of hybrid and totally electric powerplants in large buses. For example, a reduction of several thousand pounds in body weight could allow a bus to early a battery pack as part of a hybrid powertrain that allows the battery pack to recover energy for subsequent re-use. Any overall weight savings will also afford the opportunity to downsize the propulsion, braking and suspension systems to more closely match the reduced curb weight of the vehicle. The use of engineered materials allows buses to have more aesthetically pleasing styling and better aerodynamic performance (i.e., less drag), the latter also being a contributor to improved fuel economy.

The invention provides a bus body passenger section fabricated from engineered materials (reinforced plastics) offering several outstanding properties when compared with metals.

An engineered material is a combination of two or more chemically distinct and insoluble phases. Its properties and structural performance are superior to those of the constituents acting independently. Reinforcing fibers for polymer-matrix composites are generally glass, graphite, aramids, or boron.

Glass fibers are perhaps the most widely used and least expensive of all fibers. The composite material is called glass-fiber reinforced plastic and may contain between 30% and 60% glass fibers by volume. Graphite fibers, although more expensive than glass fibers, have a combination of low density, high strength, and high stiffness. The product is called carbon-fiber reinforced plastics but cost considerations would justify its use typically only in critical areas where structural reinforcement is needed.

Aramids are among the toughest fibers; they have very high specific strengths. A common aramid is marketed under the trade name “Kevlar”. Another especially strong fiber comprises boron deposited onto tungsten fibers, although boron can also be deposited onto carbon fibers. These types of fibers have properties that are desired in a bus body fuselage section, such as high strength and stiffness, both in tension and in compression, and resistance to high temperature. The specific fiber selection for a particular bus body model can be selected by using finite element analysis to estimate the maximum stresses to which a body section may be subjected.

Generally speaking, the invention relates to a motor bus body comprising a fuselage section comprising engineered material forming the roof, side walls, and floor with the engineered material joining lengthwise margins of the roof with upper lengthwise margins of the side walls and joining lengthwise margins of the floor with lower lengthwise margins of the side walls.

The forming process includes, but is not limited to 1) extrusion, 2) injection molding, and 3) vacuum-assisted, resin-transfer molding. The latter process is considered at this time to be a preferable process for creating lighter, stronger, and more reliable fuselage sections.

Vacuum-assisted, resin-transfer molding comprises arranging fiber reinforcements and core materials as inserts in a lay-up mold. The structural characteristics of those component parts can be highly engineered to create various inserts that are laid up in the lay-up mold while dry. Once the inserts have been placed, a vacuum bag is placed over the lay-up and sealed to the tool. The lay-up is then placed under vacuum, and resin is introduced via one or more resin inlet ports to be distributed through the laminate via a flow medium and series of channels, saturating the interior. The resin is allowed to cure, typically for about eight hours more or less, an amount of time that can be reduced if the mold is heated. Once the cycle has been completed, the mold is opened and the completed part removed. A colored pigment in the resin creates a part of desired color, such as School Bus Yellow.

The “one-piece” fuselage structure referred to earlier is intended to mean a passenger bus body in which the roof, the side walls, and the floor, or a section of the roof, the side walls, and the floor comprise engineered material, with engineered material of lengthwise margins of the roof joining with engineered material of the upper lengthwise margins of the side walls, and with engineered material of lengthwise margins of the floor joining with engineered material of the lower lengthwise margins of the side walls.

In one embodiment of the invention, the engineered material of lengthwise margins of the roof seamlessly joins with engineered material of the upper lengthwise margins of the side walls.

In another embodiment, the engineered material of lengthwise margins of the floor seamlessly joins with engineered material of the lower lengthwise margins of the side walls.

In still another embodiment of the invention, the engineered material of lengthwise margins of the roof seamlessly joins with engineered material of the upper lengthwise margins of the side walls and the engineered material of lengthwise margins of the floor seamlessly joins with engineered material of the lower lengthwise margins of the side walls.

Hence any particular passenger bus body may comprise a “one-piece” fuselage structure in which the roof, the side walls, and the floor were created at the same time in a mold, or a “one-piece” fuselage structure that was created by molding multiple parts in separate molds and then bonding those parts together.

Any particular “one-piece” bus body may comprise multiple “one-piece” body sections joined together by bonding one section to another end-to-end.

The invention allows a number of features, such as window openings, roof openings, floor drain openings, aisleway tread, and seat mounting holes, to be incorporated during the molding process.

The invention also provides for floor rails that run lengthwise of the body section to be formed on the exterior of the floor, regardless of the particular engineered material used. Depending on the particular engineered material, these floor rails can provide sufficient structural strength to allow various vehicle systems, such as suspensions that suspend axles, to be directly mounted to the body without a separate steel chassis frame. If the engineered material lacks the needed strength to eliminate a separate chassis frame, the floor rails can have shapes that allow them to fit and be fastened to the side rails of a separate steel chassis frame.

The resin of the engineered material can contain a colorant that imparts a desired color to the exterior of the body, such as School Bus Yellow, thereby eliminating the need to paint the body. Because the colorant penetrates the resin, scratching of the body doesn't require repair or re-painting.

Accordingly, one generic aspect of the invention relates to a passenger bus for transporting passengers comprising: a body section comprising a floor, side walls and a roof bounding an interior; a chassis supporting the body section and comprising road wheels, some of which are driven wheels that are driven by a drivetrain for propelling the bus and some of which are steered wheels that are operated by a steering wheel for steering the bus; wherein the floor, side walls, and roof of the body section comprise engineered material, with lengthwise margins of the roof joining with upper lengthwise margins of the side walls and lengthwise margins of the floor joining with lower lengthwise margins of the side walls.

A further generic aspect of the invention relates to a method of making a passenger bus body having an interior for transporting passengers. The method comprises creating a body section of engineered material comprising a floor, side walls and a roof bounding the interior with lengthwise margins of the roof joining with upper lengthwise margins of the side walls and with lengthwise margins of the floor joining with lower lengthwise margins of the side walls.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a fragmentary perspective view, schematic in nature, of a first embodiment of the invention showing a bus body of the type that requires a separate chassis frame.

FIG. 1A is a perspective view of a bus that incorporates an inventive body.

FIG. 2 is a view in the direction of arrow 2 in FIG. 1.

FIG. 3 is a fragmentary perspective view of a second embodiment of the invention showing a bus body of the type that does not require a separate chassis frame.

FIG. 4 is a view in the direction of arrow 4 in FIG. 3.

FIG. 5 is a sectional view in the direction of arrows 5-5 in FIG. 3.

FIG. 6 is a side elevation view illustrating certain principles of the invention concerning one method of making the bus body.

FIG. 7 is a side elevation view illustrating certain principles of the invention concerning another method of making the bus body.

FIG. 8 is a side elevation view showing a window installed in a window opening in the body.

### DESCRIPTION OF THE PREFERRED EMBODIMENT

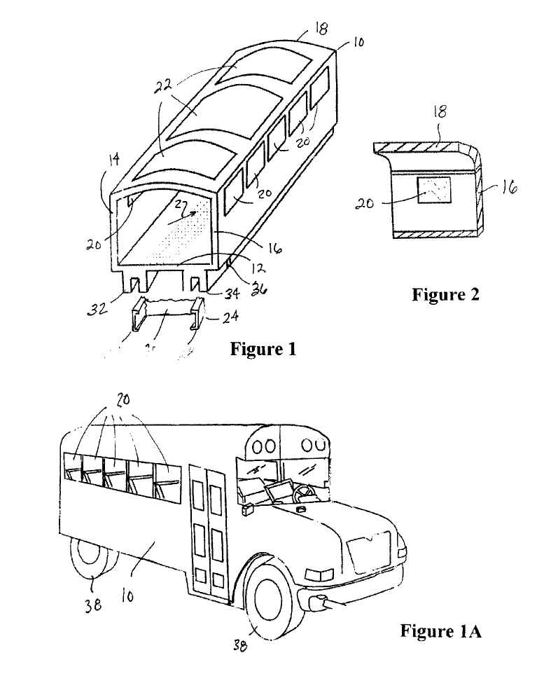

FIG. 1 shows a section 10 of a bus body embodying certain principles of the present invention. Body section 10 comprises a floor 12, side walls 14, 16 extending vertically upward along opposite lengthwise side margins of floor 12, and a roof 18 extending between top margins of side walls 14, 16. Floor 12, side walls 14, 16, and roof 18 enclose the bottom, sides, and top of an interior of the bus body.

Body section 10 shown in FIG. 1 depicts the body at an intermediate stage of the body building process where it is open at opposite lengthwise ends. At a later stage of the process, the rear lengthwise end is closed by a rear wall (not shown) that contains an emergency door and one or more rear windows. The front lengthwise end is closed by a front wall (not shown) that contains the windshield. Depending on style of bus, the front wall may either form the front of the bus or else provide a dash panel that is located below the windshield and that forms the rear wall of an engine compartment that is in front of the main body section 10.

Side walls 14, 16 contain a number of rectangular window openings 20 at intervals along their lengths. Roof 18 also contains several rectangular openings 22 that can be closed by skylights or solar panels (not shown).

As mentioned earlier, this embodiment of body requires a separate chassis frame 24 on which the body is mounted at some stage of the bus fabrication process because of the particular engineered material and process used to fabricate the roof, side walls, and floor. Frame 24 is typically steel and comprises parallel side rails 26, 28 running lengthwise of the frame and bridged at intervals along the frame length by cross members, such as the one shown at 30 in FIG. 1.

Body section 10 has features that provide a secure fit to frame 24. The particular features shown comprise downwardly open parallel channels 32, 34 that form floor rails that fit to frame side rails 26, 28. Gaps, such as 36, are present in the channels to provide clearance for frame cross members, such as 30. After body section 10 and side rails 24 have been associated with each other to place the frame side rails in channels 32, 34, they can be fastened together using any of various fastening systems that are appropriate to the respective materials of the frame and body section.

In regard to the material and process, the engineered material of body section 10 is a plastic that has been injection molded in a mold of size and shape needed for the dimensions of body section 10 which by way of example approximate those of one model of a currently manufactured metal school bus whose body's height from top of roof to floor is 6′ 10″, whose body's width as measured between outer surfaces of rub rails is 7′ 11″, whose length as measured from rear bumper to windshield is 26′ 10″ (which may be different in other models), and whose body wall thicknesses are approximately 1.5″.

In order to mold body section 10, the mold and associated molding equipment comprise multiple injection nozzles at various locations in the mold, and various inserts for openings such as the window and roof openings, and perhaps side door openings that provide passenger ingress to and egress from the bus interior. To assure that the various plastic flows properly merge within the mold cavity before curing begins, the mold may include vents where the flows merge and heating elements for assuring maintenance of plasticity until the plastic is ready to be cured. The finished body section may require removal of excess plastic material that remains in vented areas.

Curing is performed by introducing coolant into cooling passages in the mold in a manner that provides controlled, substantially uniform cooling throughout the plastic until an appropriate temperature is reached for the inserts to be retracted and the mold cavity opened.

Plastics, pellets or granules that are suitable for economical injection molding of a body part of this size by injection molding typically may not provide the degree of strength needed for suspension and drivetrain components to be mounted directly to the body channels. Hence, a bus comprising body section 10 made of injection molded plastic would typically require a frame 24 on which the various chassis components, such as suspension systems for axles, are mounted.

Because it has a constant transverse cross section, body section 10 can alternatively be fabricated by plastic extrusion in which plastic is extruded through an extrusion die having the shape of the transverse cross section. While plastic extrusion equipment would typically be less complex than injection molding equipment, extrusion would not inherently create features such as the window and roof openings, and consequently, such features would have to be created by removal of plastic from the completed extrusion. One advantage of extrusion over injection molding is that an extrusion can be cut to length, thereby allowing body sections of different lengths to be fabricated using the same extrusion die and equipment. End caps would be required with this approach, one for the front of the vehicle and one for the rear end. These two end caps would be made with an injection mold or vacuum-assisted, resin-transfer molding process. An extruded body would also typically require the use of a separate frame.

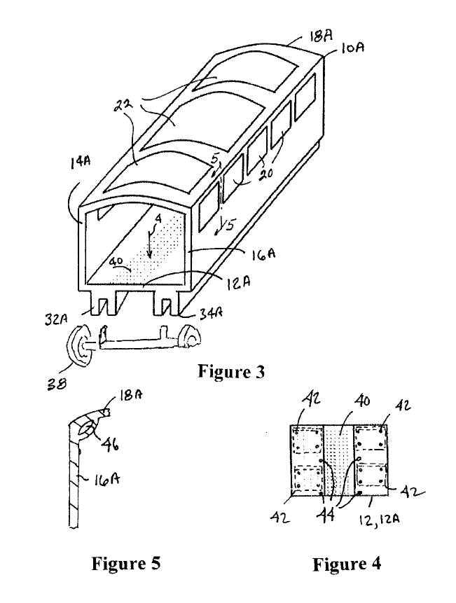

The fabrication of a body section by a process such as resin transfer molding that creates an engineered material that is a structural composite instead of merely a reinforced injection-molded or extruded plastic can create a sufficiently strong body that a separate chassis frame, such as frame 24, becomes unnecessary. FIG. 3 shows such a body section 10A that has a floor 12A, side walls 14A, 16A extending vertically upward along opposite lengthwise side margins of floor 12A, and a roof 18A extending between top margins of side walls 14A, 16A. It also has window and roof openings 20, 22 and channels 32A, 34A.

Because of the use of very strong structural composite material for body section 10, channels 32A, 34A can provide floor rails that take the place of frame side rails thereby rendering the use of a separate chassis frame unnecessary. FIG. 3 shows an axle assembly 38 that mounts directly to the floor rails via a suspension system.

The process of the invention allows certain features to be incorporated into the body sections 10, 10A during body fabrication.

A tread 40 can be formed on the interior of the floors 12, 12A, running lengthwise of the body section along an interior aisleway. A separate runner on the floor therefore becomes unnecessary.

The floors 12, 12A can have features for mounting passenger seats, such as patterns of through-holes 42 to either side of the aisleway, as shown in FIG. 4.

The floors 12, 12A can have one or more floor drain openings 44, also shown in FIG. 4, through which wash water dispensed onto the interior of the floor can drain. This allows the floors to be conveniently washed with a hose.

FIG. 5 shows an example of a channel, or duct, 46 running along the length of the body section. Such a feature can be shaped and sized to provide an air distribution duct and/or a conduit for wiring, hoses, etc. After fabrication of the body section, it may be necessary to create openings through the wall of such channels or ducts to allow wires or hoses to enter and exit or to mount airflow registers.

The body can be styled for aesthetic and aerodynamic considerations.

Any particular bus may comprise one or more body sections, 10, 10A. FIG. 7 shows two such sections 10 that are intended to be joined together. While joining separate sections to each other would involve an added assembly step, the mold needed to fabricate each section would be smaller than one of needed to fabricate a one-section bus body having the same overall length as the joined smaller sections.

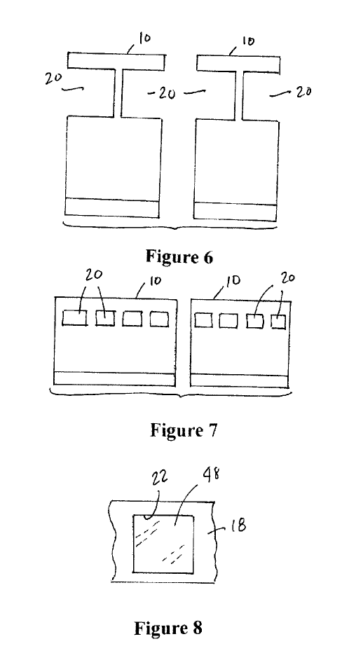

FIG. 6 shows an alternate construction where individual body sections 10 end at the midpoints of the window openings 20.

FIG. 8 shows a skylight 48 mounted in a roof opening 22. Windows can be mounted in the window openings in a similar way.

While it is to be understood that certain operations on a molded body will typically be needed as the body is being completed, principles of the present invention can enable a passenger bus to be built with a fewer individual parts, with fewer hours of labor, and in less floor space. The inventive body has a structure of significantly reduced weight that provides comparable, or in the case of composite material, increased strength and rigidity, relative to buses currently manufactured by the fabrication process described earlier. Weight minimization and durability are, and will continue to be, critical priorities in the manufacture of large vehicles like passenger buses.

The inventive body is not prone to rusting or need for re-painting. Because of its attributes it can promote customer satisfaction, value, and increased sales for a bus manufacturer.

FIG. 1A shows a typical school bus that has a body fabricated in accordance with principles of the invention. The front of the body ends at a forward engine compartment.

While a presently preferred embodiment of the invention has been illustrated and described, it should be appreciated that principles of the invention apply to all embodiments falling within the scope of the following claims.

What is claimed is:

1. A passenger bus for transporting passengers comprising:
a body section comprising a floor, side walls and a roof bounding an interior;
a chassis supporting the body section and comprising road wheels, some of which are driven wheels that are driven by a drivetrain for propelling the bus and some of which are steered wheels that are operated by a steering wheel for steering the bus;
wherein the floor, side walls, and roof of the body section each comprises engineered material with lengthwise margins of the roof joining with upper lengthwise margins of the side walls and lengthwise margins of the floor joining with lower lengthwise margins of the side walls.

2. A passenger bus as set forth in claim 1 wherein the chassis comprises a chassis frame having right and left side rails that that run lengthwise of the frame and comprise engineered material seamlessly joining with engineered material of the floor.

3. A passenger bus as set forth in claim 2 further including a suspension via which at least some of the wheels are suspended from the right and left side rails.

4. A passenger bus as set forth in claim 1 wherein the chassis comprises a chassis frame having right and left metal side rails that that run lengthwise of the frame, and the engineered material of the floor includes formations that define floor rails run lengthwise of the body section and that are fit and fastened to the side rails of the chassis frame.

5. A passenger bus as set forth in claim 4 wherein the chassis frame comprises at least one cross member bridging the metal side rails and the floor rails comprise gaps at each such cross member that allow the floor rails to fit to the metal side rails.

6. A passenger bus as set forth in claim 1 wherein the engineered material of the floor includes formations that define floor rails running lengthwise of the body section on the exterior of the body section.

7. A passenger bus as set forth in claim 6 wherein the side walls of the body section comprise window openings spaced apart lengthwise of the body.

8. A passenger bus as set forth in claim 7 wherein the roof of the body section comprises at least one opening.

9. A passenger bus as set forth in claim 6 wherein the body section comprises one or more channels running lengthwise of the body section on the interior of the body section.

10. A passenger bus as set forth in claim 6 wherein the engineered material of the floor comprises a tread on the interior of the body section running lengthwise of the body section along an interior aisleway.

11. A passenger bus as set forth in claim 10 wherein the floor comprises a pattern of through-holes to either side of the aisleway for mounting passenger seats on the floor.

12. A passenger bus as set forth in claim 6 wherein the floor comprises one or more floor drain openings through which wash water dispensed onto the interior of the floor can drain.

13. A passenger bus as set forth in claim 6 wherein the engineered material comprises a colorant that imparts a desired color to the exterior of the body.

14. A passenger bus as set forth in claim 6 wherein the engineered material comprises a structural composite made by other than extrusion or injection molding.

15. A passenger bus as set forth in claim 6 wherein the engineered material comprises a reinforced plastic resin that has been either extruded or injected.

16. A passenger bus as set forth in claim 1 comprising a second body section joining with the first-mentioned one and comprising a floor, side walls, and a roof each comprising engineered material with lengthwise margins of its roof joining with upper lengthwise margins of its side walls and lengthwise margins of its floor joining with lower lengthwise margins of its side walls, and wherein the engineered material of the floor of the further body section includes formations that define floor rails aligning with those of the first-mentioned body section.

17. A method of making a passenger bus body having an interior for transporting passengers, the method comprising:
in a mold, forming a body section comprising a floor, side walls and a roof bounding the interior by introducing resin and reinforcing fibers into a cavity of the mold that causes the introduced resin to seamlessly join lengthwise margins of the roof with upper lengthwise margins of the side walls and to seamlessly join lengthwise margins of the floor with lower lengthwise margins of the side walls.

18. A method as set forth in claim 17 wherein the mold is shaped to cause the introduced material to create floor rails running lengthwise of the body section on the exterior of the floor.

19. A method as set forth in claim 18 wherein the step of forming the body section comprises injection molding.

20. A method as set forth in claim 18 wherein the step of forming the body section comprises extrusion.
